(19) United States
(12) Patent Application Publication
(10) Pub. No.: US 2003/0023537 A1
(43) Pub. Date: Jan. 30, 2003

(54) System and method for negotiating prices in an automated auction forum

(76) Inventors: Rohit Ricky Joshi, Blacklick, OH (US); Eric M. Etu, Queensbury, NY (US); Pranab Pradhan, Redwood City, CA (US); Kapil K. Jain, Hanover, NH (US); Tikhon Bernstam, Palo Alto, CA (US)

Correspondence Address: McLane, Graf, Raulerson & Middleton, Professional Association, 900 Elm Street, P.O. Box 326, Manchester, NH, 03105-0326, US

(21) Appl. No.: 09/915,720

(22) Filed: Jul. 26, 2001

(51) Int. Cl. G06F 17/60

(52) U.S. Cl. 705/37

(57) ABSTRACT

An auction forum in an interactive computer system negotiates the price of an item on behalf of the seller with a bidder. The system calculates an acceptable bid based on seller input including such variable as a reserve price and hardness of the sale. The bidder haggles with the computer and tries to offer an acceptable bid based on the seller's asking price and the duration of the auction. The computer system tracks the bidder's progress towards an acceptable bid, giving the bidder a limited number of opportunities to offer an acceptable bid in each session.

### FIELD OF THE INVENTION

This invention generally relates to interactive computer systems and, in particular, to automated, web-based, real-time auction forums.

### BACKGROUND OF THE INVENTION

Commercial and auction sites on the Internet for the sale of goods or services are well known. Commercial sites typically contain a description of the items to be sold including a set price. Auction sites allow buyers to bid on the item described, so that the item price is not static or pre-set. Neither of these options allows the buyer to negotiate, or haggle, with the seller in an interactive computer environment.

U.S. Pat. No. 6,035,288, issued to Solomon, recognizes this need. The patent discloses a computer-implemented method and system for negotiating the purchase of goods or services utilizing a simulated human merchant having predefined behavioral attributes. An algorithm representing these attributes is used to receive customer input data, which is processed to generate merchant responses. The sale of goods or services is agreed to at a particular price as a result of processing of customer replies to merchant responses according to the algorithm.

The above patent relies on an algorithm that simulates a merchant's mood and behavior. Behavioral attributes, representative emotional states, and customer response to presented questions determine the negotiations. While certain embodiments contained in the patent allow “upsells” to obtain a better price for the seller, the algorithm does not rely directly on the seller's desired price. To determine price, the '288 patent relies on a business model including such variables as gathered knowledge about the item for sell, reasonable prices through other channels, and a targeted revenue distribution for each particular product.

Therefore, what is needed is a method for negotiating prices in an interactive computer system that takes into account variable such as the seller's desired price, lowest allowed price, and a variable to allow various hard or soft selling styles. An online auction forum to implement such a method and allows the seller to more directly control the negotiated price is also needed.

### SUMMARY OF THE INVENTION

The present invention provides an automated, web-based, real-time auction forum that allows sellers to sell items not just at a prescribed price, nor necessarily to the highest potential bidder, but to the first bidder who haggles with the web site (which represents the seller) until a middle ground price is reached. The determination of price does not result from a traditional auction sequence as much as it does a one-on-one haggling sequence. This haggling may take on the feel of a yard sale, which is intended to add to the enjoyment of the process.

The present invention includes both a selling process and a buying process. In the selling process, the seller places an item for sell for a certain duration and describes the item. The description is displayed on the web site to potential buyers. The seller selects a reserve price, which will not be shown to buyers, and an ask price, which is shown to buyers with the description of the item. The reserve price represents the minimum price at which the seller will sell the item, while the asking price represents the maximum price, or the starting price for negotiation. The seller also selects a hardness of sale factor, which is not shown to the buyer. This factor represents the negotiating style of the seller for that item. In a hard sell, less deviation from the asking price occurs. In a softer or more urgent sell, the system will be more likely to sell the item closer to the reserve price.

Once an item or service is listed and displayed, the buying process continues. Upon finding a desired item, the buyer can read feedback and ratings of the seller by other users. The buyer then may place a bid on the item through the interactive computer system. The system determines whether the bid is acceptable using an algorithm based on the duration of the sale, the reserve price, the asking price, and the hardness variable. If the bid is acceptable, the system accepts the bid for the seller and the transaction is completed. If the bid is found unacceptable, the system may supply a counter bid, and the buyer may bid again. In subsequent bids, a “happiness” variable is factored into the bid acceptance dependent on the buyer's previous bids, which variable tracks the buyer's progress towards an acceptable bid. A predetermined number of bids may be set as the limit for the buyer to offer an acceptable bid, and the buyer is free to leave the bidding process at any time.

Therefore, it is an aspect of this invention to provide an interactive computer system for negotiating prices of items for sale.

It is another aspect of the invention to provide an interactive computer system that negotiates on behalf of a seller with a buyer.

It is a further aspect of the invention to provide an interactive computer negotiating system that allows the seller to determine a minimum and maximum price for an item to be sold.

It is another aspect of the invention to allow an interactive computer system to act as proxy for a seller and negotiate prices with a buyer based on predetermined pricing information provided by the seller.

It is yet another aspect of the invention to provide an interactive computer negotiating system that accepts bids from sellers based on predetermined criteria entered by a seller.

It is still another aspect of the invention to allow an interactive computer negotiating system to offer counter bids based on predetermined criteria in response to a buyer's bids.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

FIG. 1 is a flow chart of the selling process included in the present invention.

FIG. 2 is a flow chart of the buying process included in the present invention.

### DETAILED DESCRIPTION OF THE INVENTION

The present invention can be broken down into a selling process and a buying process. Together, these two processes comprise an automated, interactive auction forum. The automated auction forum of the present invention is preferably software used in an interactive computer system, specifically on a Web site. In this manner, the experience of negotiating or haggling over a price can be experienced in an on-line forum.

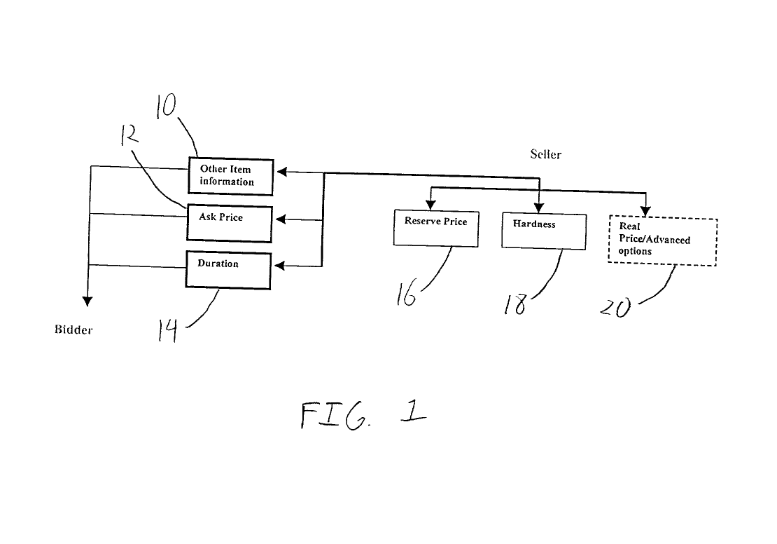

The selling process begins with the seller entering certain data relevant to the auction into a database. The seller's input is shown in the flow chart of FIG. 1. As can be seen from the flow chart, only certain data entered by the seller will be seen by the bidder. Description 10, labeled “Other Item Information” on the chart, will be the bulk of the data displayed to the seller. Description 10 describes the goods or services offered, the condition or quality of these items, and preferably includes a graphic representation of the items. Any other information deemed relevant to the auction may be entered here as well.

Also displayed to the bidder is ask price 12. Ask price 12 represents the initial offer of the seller or the maximum price at which an item will be sold. It is the price at which haggling for the item will begin. As ask price 12 is visible to the bidder, first bids are made in response to the ask price during the buying process. First bids can also depend on duration 14, another variable visible to the bidder. Duration 14 is the maximum amount of time the seller will leave the item up for sell. In some embodiments, only the ending time of duration 14 may be shown to the bidder, and not the elapsed time. If the item does not sell within the time allotted for duration 14, the item is automatically removed from the auction forum with no transaction taking place.

The seller enters other variables and data not seen by the bidder. Reserve price 16 is the minimum price the seller will accept for an item. Bids below reserve price 16 will never be accepted by the computer system. As the seller generally wishes to sell the item at a price closer to ask price 12 to earn more money, reserve price 16 is kept hidden from the bidder.

The seller also selects hardness 18, a variable representing how strict the seller wishes the computer system to keep to ask price 12. This variable is also kept hidden from the bidder. Hardness 18 may be represented by a percentage (between 0 and 100 inclusive). In the preferred embodiment, the seller selects on of four predetermined settings for the hardness. This represents the urgency of the sale and giving a basis for the selling strategy employed by the system. A high hardness value instructs the system not to accept bids that vary greatly from ask price 12, as the seller wishes to sell the item close to the ask price. Similarly, a low hardness value instructs the system to move from ask price 12 quickly (but never below reserve price 16) as the seller is more interested in moving the item than in selling the item for the ask price.

Finally, the seller adds additional criteria 20, which includes a real price. The real price represents a price between ask price 12 and reserve price 16. This real price is a number representing the price a seller would like to reasonably obtain for the auction item. The real price is used in an algorithm described below to calculate the aim price for each bid. Any bid greater than the calculated aim price will immediately be accepted by the system. The role of the aim price is described in greater detail below. Also, in some embodiments of the invention, other more advanced options may be entered as part of additional criteria 20.

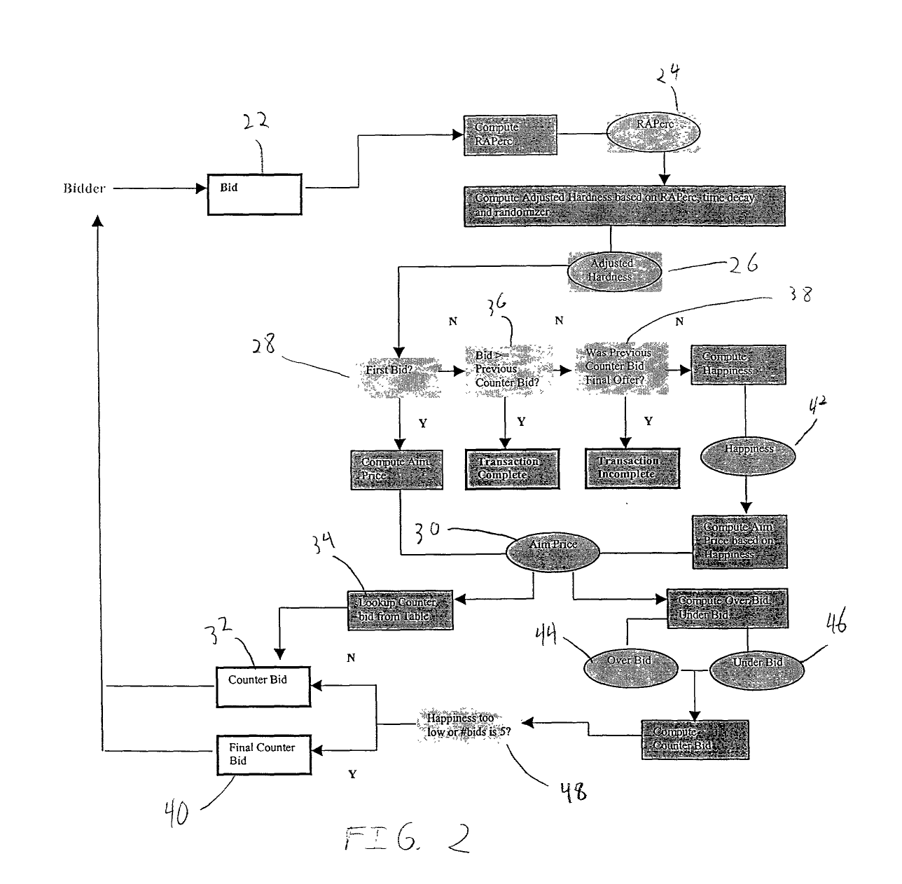

The data displayed to the bidder is used by the bidder in the buying process. The data and variables hidden from the bidder are used by the system to determine what constitutes an acceptable bid. Using the data displayed, the bidder offers bid 22, which is generally lower than ask price 12. The computer system them follows an algorithm as set out in the flow chart of FIG. 2 to determine if bid 22 is an acceptable bid. In the preferred embodiment, the bidder only has a preset number of chances, generally five, to offer an acceptable bid.

As seen in FIG. 2, the computer first calculates RAPerc 24, or a reserve-ask percentage. RAPerc 24 is simply the percentage that ask price 12 is greater than reserve price 16. RAPerc 24 is used with ask price 12 to affect hardness 18 via a stretched logarithmic curve. In this manner, ask price 12 will be more firm (by calculating a higher aim price as described below) for higher ticket items because RAPerc 24 has a decreasing effect on hardness 18 as ask price 12 grows.

The computer system then calculates adjusted hardness 26. To find adjusted hardness 26, hardness 18 is adjusted using RAPerc 24, a time decay variable, and a randomizer. As described above, the RAPerc adjusts the hardness directly proportional to a logarithm of ask price 12. The greater RAPerc 24 is, the more positive influence it will impose on adjusted hardness 26, as a high RAPerc demonstrates a desire to sell the item close to ask price 12. The time decay variable, which works on an exponential decay curve, functions to decrease adjusted hardness 26, thus making the sale more likely as time passes to the conclusion of the auction. The randomizer is inserted to protect the integrity of the algorithm. It can also be seen as adding a pinch of luck in the eyes of the bidder. The randomizer minutely affects adjusted hardness 26 based on a randomly produced decimal. Preferably, adjusted hardness 26 is affected by the randomizer by no more than plus or minus one percent. While these variables each change adjusted hardness 26, all three variables have less effect than the seller's actual hardness input.

As shown at box 28, the computer system must determine if bid 22 is the first bid. The answer to this question determines how aim price 30 is calculated. If bid 22 is the first bid, the computer system immediately calculates aim price 30. In this situation, aim price 30 is found by taking the difference between ask price 12 and reserve price 16. The difference is then multiplied by adjusted hardness 26, which is represented as a percentage. The resulting product is added to reserve price 16 to produce a calculated price. Finally, the real price, entered by the seller as part of additional criteria 20, exerts a 30% influence on this calculated price to create aim price 30.

Once the aim has been calculated for the initial bid, the computer system will compare bid 22 to aim price 30. If bid 22 is greater than or equal to aim price 30, the bid is accepted on behalf of the seller and negotiations end. The auction listing is removed from the auction forum and the bidder is billed for the amount of bid 22. If bid 22 is less than aim price 30, the computer system will return counter bid 32 to the bidder. In the case of the initial bid, counter bid 32 is found by creating two-dimensional table 34, which returns a percentage that the computer system should come down from the from ask price 12. This percentage is based only on ask price 12 and reserve price 16, which are the X and Y variables of table 34.

Returning to box 28, if bid 22 is not the first bid, the computer system proceeds to comparison 36, which compares bid 22 to the previous counter bid 32. If bid 22 is greater or equal to counter bid 32 generated by the computer system, the transaction is complete and the listing is removed from the auction forum, the bidder having won the auction. If bid 22 is less than previous counter bid 32, the computer system then determines question 38, which asks if the previous counter bid was final counter bid 40. The method for arriving at final counter bid 40 is detailed below. If the previous counter bid is final counter bid 40 haggling ends with the transaction incomplete, as the bidder has rejected final counter bid 40. The item remains unsold and another bidder may enter the haggling process.

If previous counter bid 32 was not a final counter bid, the computer system calculates happiness variable 42. Happiness 42 is determined based on how well the bidder is progressing towards aim price 30 by deciding if the bidder is increasing bid 22 enough to truly be negotiating a price. Happiness 42 is found by creating a lower bound on what is considered an acceptable bid. This lower bound is initially determined by subtracting hardness 18 from the number two. This difference is multiplied by the difference between ask price 12 and reserve price 16, and the resulting product id subtracted from reserve price 16. If this calculation results in a negative value, the lower bound is set to zero. A bid lower than this lower bound is scored a one. The region between the lower bound and aim price 30 is divided into four intervals, scored 2 through 5 respectively. The intervals shrink exponentially as the score gets higher. The computer system determines in what interval bid 22 falls and scores the bid accordingly. For subsequent bids, the lower bound is set at the bidder's previous bid. Happiness 42 is a sum of the scores from all bids, thus the value of happiness 42 changes after each bid.

Once happiness 42 is updated, the computer system finds new aim price 30. the current happiness value affects aim price 30 slightly. Happiness 42 and aim price 30 have an inverse linear relationship. Thus, a high happiness value lowers the aim price (slightly) and a low happiness value raises the aim price. As such, high bidding is rewarded.

Two values dependent on aim price 30 are over bid 44 and under bid 46. These values help determine counter bid 32 in bids after the first as described below. Over bid 44 is the difference between ask price 12 and aim price 30. Under bid 46 is the difference between aim price 30 and the most recent bid 22.

At this point, the computer system once again compares bid 22 to aim prices 30. As with the initial bid, if bid 22 is greater than or equal to the aim price, the transaction is completed with the bidder winning the auction. If bid 22 is lower than aim price 30, the computer system must compute counter bid 32. Counter bid 32 is simply determined by coming down from ask price 12 the same percentage that the bidder has come up from the previous bid. Over bid 44 and under bid 46 are used to find these values. Namely, counter bid 32 is found by coming down from ask price 12 by the value of over bid 44 for each value of under bid 46 that the bidder came up from the previous bid. For example, if the over bid was one dollar and the under bid four dollars, the counter bid would be one dollar less than ask price 12 for every four dollars the bidder increased the previous bid. As these values change with each bid, the change from the ask price will be a different dollar a mount from one bid to the next.

Before displaying counter bid 32 to the bidder, the computer system must make determination 48, which determines if counter bid 32 will become final counter bid 40. The counter bid will be final counter bid 40 if one of two conditions is met. First, in the preferred embodiment of the invention, the bidder is only given five opportunities to offer bid 22. Once the fifth opportunity has occurred and the transaction has not been completed, final counter bid 40 is offered. additionally, if happiness 42 falls below a preset value, the computer system will cut short the bidding process and offer up final counter bid 40. This represents a seller's unhappiness with the bidding process thus far. Happiness 42 is a variable kept hidden from the bidder. In the preferred embodiment, if the happiness value falls below an average of 2.5 per bid, final counter bid 40 will be offered.

Once final counter bid 40 is displayed to the bidder, the bidder is in a take it or leave it situation. The bidder can no longer offer a new bid, but can only accept or reject final counter bid 40. If the bidder accepts the final counter bid, the transaction is completed just as if the computer system had accepted bid 22, with the final counter bid being the purchase price. If the bidder rejects the final counter bid, the bidding sequence ends without a transaction

In addition to the buying and selling processes described above, embodiments of the present invention may include additional features. For example, the bidder interacts with the computer system through an interface designed to act as the bidder's agent. The agent is a fictional character the bidder can choose, which has no impact on prices, but may add a real-world and user-friendly interface between the software and the computer. Additional features may be added to provide the user with additional information or protection. A registration system may be included to provide contact and payment information for sellers and bidders. A feedback section will allow bidders and sellers to publicly comment, praise, or complain about the transaction.

Although the present invention has been described with reference to certain preferred embodiments thereof, other versions are readily apparent to those of ordinary skill in the art. Therefore, the spirit and scope of the appended claims should not be limited to the description of the preferred embodiments contained herein.

What is claimed is:

1. An interactive computer system for an automated auction forum, said system comprising:
a database containing information describing an auction entered by a seller;
interface means for enabling a bidder to input a bid in said auction in response to portions of said information displayed to said bidder from said database; and
a database engine utilizing said information to calculate counter bids in response to said bidder;
wherein said bidder enters bids and said database engine produces counter bids until a price is negotiated with said bidder on behalf of said seller.

2. The interactive computer system of claim 1, wherein said information entered by said seller comprises a maximum price, a minimum price, a real price, a description, a hardness of sell variable and a duration.

3. The interactive computer system of claim 2, wherein said database engine calculates an aim price based on said information entered by said seller, and wherein said database engine compares said bids entered by said bidder to said aim price to determine if said bid is accepted.

4. The interactive computer system of claim 3, wherein said database engine calculates a happiness variable based on the proximity of said bids entered by said bidder to said aim price.

5. The interactive computer system of claim 4, wherein said database engine tracks said happiness variable in relation to a lower bound, and wherein if said happiness variable falls below said lower bound said database engine offers a final counter bid.

6. The interactive computer system of claim 5, wherein said database engine includes a preset limit on the number of bids entered by said bidder, and wherein said database engine offers a final counter bid when said preset limit is reached.

7. A computer implemented method for running an automated auction forum, said method comprising the steps of:
storing information entered by a seller;
receiving a bid entered by a bidder;
calculating an aim price based on said information entered by said seller;
comparing said bid entered by said bidder to said aim price;
computing a happiness variable based on the proximity of said bid to said aim price;
offering a counter bid based on said bid and said aim price;
determining if said counter bid is a final counter bid based on said happiness variable; and
repeating the steps until said bid matches or exceeds said aim price or until a final counter bid is offered;
wherein a price is found through a process of negotiation with said bidder on behalf of said seller.

8. The method as claimed in claim 7, wherein said final counter bid is offered if a preset number of bids has been received.

9. The method as claimed in claim 7, wherein said information entered by said seller includes a description of an item, a duration of the auction, a maximum selling price, a minimum selling price, a real price, and a hardness of sell variable.

10. The method as claimed in claim 9 further comprising the steps of finding a percentage that said maximum selling price is greater than said minimum selling price, and adjusting said hardness of sell variable based said percentage, a time decay variable based on said duration, and a randomizer variable.

11. The method as claimed in claim 10, wherein said aim price is calculated utilizing said adjusted hardness of sell, said maximum selling price, said real price, and said minimum selling price.

12. The method as claimed in claim 11, wherein said aim price is further calculated utilizing said happiness variable.

13. The method as claimed in claim 7 further comprising the final step of allowing said bidder to accept or reject said final counter bid.

14. A computer implemented method for running an automated auction forum, said method comprising the steps of:
storing information entered by a seller, said information comprising an item description, a maximum selling price, a minimum selling price, a real price, a duration of sale, and a hardness of sell variable;
receiving a bid entered by a bidder;
finding a percentage that said maximum selling price is greater than said minimum selling price;
adjusting said hardness of sell variable based said percentage, a time decay variable based on said duration, and a randomizer variable;
calculating an aim price based on said adjusted hardness of sell, said maximum selling price, said minimum selling price, and said real price;
comparing said bid entered by said bidder to said aim price;
computing a happiness variable based on the proximity of said bid to said aim price;
offering a counter bid based on said bid and said aim price;
determining if said counter bid is a final counter bid based on said happiness variable;
repeating said steps until said bid matches or exceeds said aim price or until a final counter bid is offered; and
allowing said bidder to accept or reject said final counter bid;
wherein a price is found through a process of negotiation with said bidder on behalf of said seller.

15. The method as claimed in claim 14, wherein said final counter bid is offered if a preset number of bids has been received.

16. The method as claimed in claim 14 further comprising the step of recalculating said aim price based on said happiness variable after a first bid has been received.
